(19) United States
(12) Patent Application Publication
(10) Pub. No.: US 2025/0182355 A1
(43) Pub. Date: Jun. 5, 2025

(54) REPEATED DISTRACTOR DETECTION FOR DIGITAL IMAGES

(71) Applicant: Adobe Inc., San Jose, CA (US)

(72) Inventors: Yuqian Zhou, Bellevue, WA (US); Zhe Lin, Clyde Hill, WA (US); Sohrab Amirghodsi, Seattle, WA (US); Elya Schechtman, Seattle, WA (US); Connelly Stuart Barnes, Seattle, WA (US); Chuong Minh Huynh, Hyattsville, MD (US)

(73) Assignee: Adobe Inc., San Jose, CA (US)

(21) Appl. No.: 18/527,881

(22) Filed: Dec. 4, 2023

(51) Int. Cl. G06T 11/60; G06T 7/12; G06T 7/70; G06V 10/25; G06V 10/44; G06V 10/74

(52) U.S. Cl. CPC G06T 11/60; G06T 7/12; G06T 7/70; G06V 10/25; G06V 10/44; G06V 10/761; G06V 2201/07

(57) ABSTRACT

Repeated distractor detection techniques for digital images are described. In an implementation, an input is received by a distractor detection system specifying a location within a digital image, e.g., a single input specifying a single set of coordinates with respect to a digital image. An input distractor is identified by the distractor detection system based on the location, e.g., using a machine-learning model. At least one candidate distractor is detected by the distractor detection system based on the input distractor, e.g., using a patch-matching technique. The distractor detection system is then configurable to verify that the at least one candidate distractor corresponds to the input distractor. The verification is performed by comparing candidate distractor image features extracted from the at least one candidate distractor with input distractor image features extracted from the input distractor.

### BACKGROUND

Distractors refer to visual objects included in a digital image that divert attention from an overall purpose of the digital image. Accordingly, distractors are not limited to visual artifacts included in the digital image (e.g., dust) but also include depictions of physical objects within the digital image that divert attention from a depiction of a target physical object in the digital image. Consider an example in which a digital image is captured of a human being in a fall setting. Leaves on the tree are not considered distractors because these leaves are expected as part of the digital image and do not divert attention away from the human being. However, leaves that are floating in the air do divert attention away from the human being, and therefore are considered distractors in this instance.

Accordingly, conventional techniques used to address distractors are confronted with technical challenges caused by a variety of objects and scenarios in which the objects are considered distractors. Additionally, conventional techniques are also confronted with a potentially large number of distractors (e.g., raindrops in the sky) that are difficult in conventional techniques to manually select individually, which causes errors, inefficient use of processing resources, and so forth.

### SUMMARY

Repeated distractor detection techniques for digital images are described. In an implementation, an input is received by a distractor detection system specifying a location within a digital image, e.g., a single input specifying a single set of coordinates with respect to a digital image. An input distractor is identified by the distractor detection system based on the location, e.g., using a machine-learning model. At least one candidate distractor is detected by the distractor detection system based on the input distractor, e.g., using a patch-matching technique. The distractor detection system is then configurable to verify that the at least one candidate distractor corresponds to the input distractor. The verification is performed by comparing candidate distractor image features extracted from the at least one candidate distractor with input distractor image features extracted from the input distractor.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ repeated distractor detection techniques for digital images as described herein.

FIG. 2 depicts an example of selection, detection, indication, and removal of distractors from a digital image in a user interface.

FIG. 3 depicts a system in an example implementation showing operation of a distractor detection system of FIG. 1 in greater detail as detecting distractors that are repeated in a digital image responsive to a single user input.

FIG. 4 depicts a system in an example implementation showing operation of a candidate distractor detection module of FIG. 3 in greater detail as generating at least one candidate distractor based on an input distractor.

FIG. 5 depicts an example of an architecture of one or more machine-learning models configurable to implement the candidate distractor detection module of FIG. 4.

FIG. 6 depicts an example of an architecture of one or more machine-learning models configurable to implement the candidate distractor verification module of FIG. 3.

FIG. 7 depicts an example algorithm of iterative distractor selection.

FIG. 8 is a flow diagram depicting an algorithm as a step-by-step procedure in an example implementation of operations performable for accomplishing a result of automated repeated distractor detection and removal.

FIG. 9 illustrates an example system including various components of an example device that can be implemented as any type of computing device as described and/or utilize with reference to 1-8 to implement embodiments of the techniques described herein.

### DETAILED DESCRIPTION

### Overview

Distractors in a digital image refer to depictions of objects that divert a viewer's attention away from an overall purpose of the digital image. Accordingly, distractors include visual artifacts (e.g., capture of dust and raindrops on a lens) as well as depictions of objects that while included naturally as part of the digital image distract from the overall purpose digital image, e.g., depictions of leaves, outlets on a wall, fence posts in a landscape, and so forth. Conventional techniques used to address distractors, therefore, are confronted with technical challenges in identifying what is considered a distractor in a digital image as well manual selection of a potential multitude of distractors included in the digital image, e.g., water droplets caused by splashing water.

Accordingly, repeated distractor detection techniques for digital images are described. These techniques are configured to address technical challenges in identifying what is considered a distractor in a digital image as well as how to support group selection of distractors, e.g., based on a single input.

In one or more examples, a distractor detection system employs a distractor segmentation module that receives a single input detected via a user interface, e.g., a “click” or “tap” identifying coordinates within a user interface with respect to a digital image. The distractor segmentation module then detects an input distractor based on the single input. The distractor segmentation module, for instance, generates an input distractor segmentation mask that identifies a portion of the digital image corresponding to the distractor. The distractor segmentation module does so by based on segmentation techniques that leverage machine learning as implemented using a machine-learning model. The single input, for instance, is used to guide segmentation of a single object within the digital image by the machine-learning model to form the input distractor segmentation mask.

A candidate detection module is then utilized to detect a candidate distractor based on the input distractor, e.g., to identify another distractor included in the digital image that is visually similar to the input distractor. To do so, features are extracted from the input distractor (e.g., using a machine-learning model) that are compared with features extracted from other regions (e.g., patches) within the digital image to find a “match.” The extracted features, for instance, are considered a match when corresponding to each other within a threshold amount of visual similarity as defined using vectors of the extracted features in a feature space.

Once the region is identified, in one or more implementations, a regression operation is utilized by the distractor detection module to identify a candidate distractor location within the digital image. The candidate distractor location therefore functions similarly to a single input as described above to define a location of the input distractor. Accordingly, the candidate distractor location is usable to generate a candidate distractor segmentation mask that identifies the candidate distractor using similar segmentation techniques implemented using machine learning by a machine-learning model as described above.

In one or more examples, a candidate distractor verification module is utilized to verify that the candidate distractor identified by the candidate distractor segmentation mask corresponds to the input distractor identified by the input distractor segmentation mask. To do so, candidate distractor image features extracted from the candidate distractor using a machine-learning model are compared with input distractor image features extracted from the input distractor using the machine-learning model.

Once verified, the distractors (e.g., the input distractor and the candidate distractors) are output, e.g., for identification in a user interface and/or automated distractor removal using object removal techniques. This process is performable iteratively to increase a likelihood of accurate identification of similar distractors in the digital image. In this way, a single input (e.g., a single set of coordinates detected with respect to a digital image in a user interface) is usable to remove a multitude of distractors from a digital image, automatically and without user intervention. Further discussion of these and other techniques is included in the following sections and shown in corresponding figures.

In the following discussion, an example environment is described that employs the repeated distractor detection techniques described herein. Example procedures are also described that are performable in the example environment as well as other environments. Consequently, performance of the example procedures is not limited to the example environment and the example environment is not limited to performance of the example procedures.

### Example Distractor Detection Environment

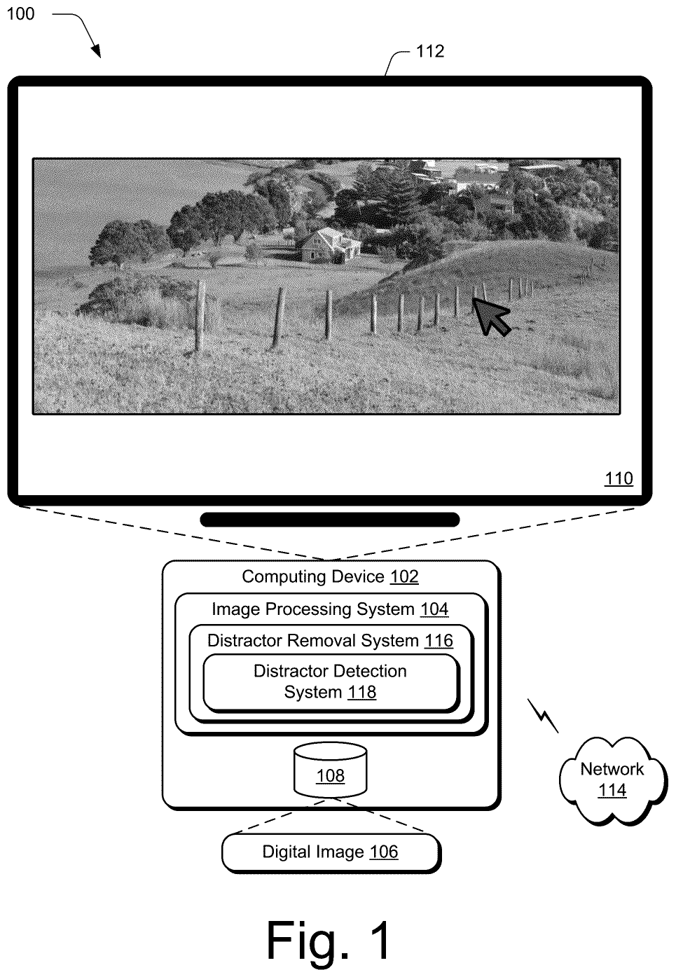

FIG. 1 is an illustration of a digital medium environment 100 in an example implementation that is operable to employ repeated distractor detection techniques for digital images as described herein. The illustrated environment 100 includes a computing device 102, which is configurable in a variety of ways.

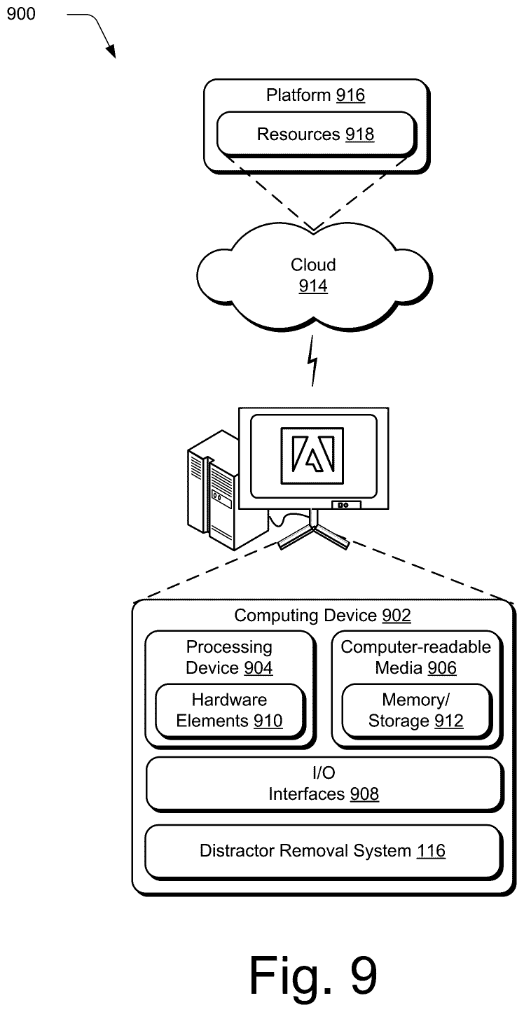

The computing device 102, for instance, is configurable as a desktop computer, a laptop computer, a mobile device (e.g., assuming a handheld configuration such as a tablet or mobile phone), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including an image processing system 104. The image processing system 104 is implemented at least partially in hardware of the computing device 102 to process and transform a digital image 106, which is illustrated as maintained in a storage device 108 of the computing device 102. Such processing includes creation of the digital image 106, modification of the digital image 106, and rendering of the digital image 106 in a user interface 110 for output, e.g., by a display device 112. Although illustrated as implemented locally at the computing device 102, functionality of the image processing system 104 is also configurable as whole or part via functionality available via the network 114, such as part of a web service or “in the cloud.”

An example of functionality incorporated by the image processing system 104 to process the digital image 106 is illustrated as a distractor removal system 116. The distractor removal system 116 is configured to support automated detection and removal of distractors within the digital image 106. As part of this, the distractor removal system 116 employs a distractor detection system 118 that is configured to detect repeated distractors in a digital image, e.g., based on a single user input.

In the illustrated example, for instance, an input is received that indicates a single set of coordinates (e.g., X/Y coordinates) with respect to a digital image 106 displayed in a user interface 110 by the display device 112. In response, the distractor detection system 118 detects an input distractor as corresponding to the single set of coordinates, locates candidate distractors based on the input distractor, verifies visual similarity of the candidate distractors to the input distractor, and is configurable to automatically remove the distractors without user intervention responsive to the input. This process supports iteration to address a multitude of potential distractors and as such overcomes the technical challenges of conventional techniques.

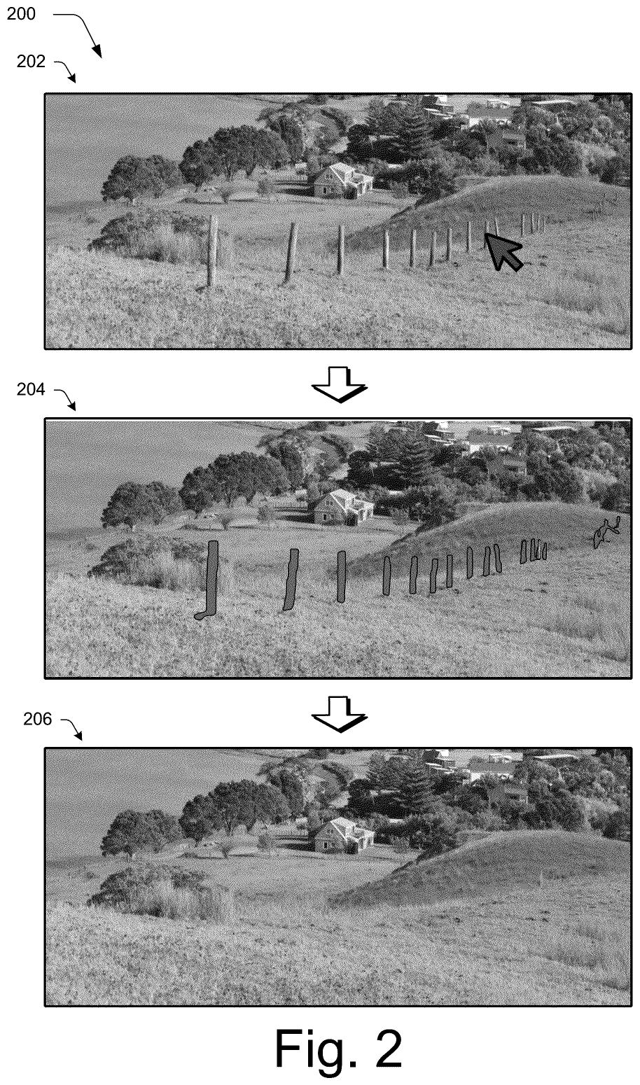

FIG. 2 depicts an example 200 of selection, detection, indication, and removal of distractions from a digital image in a user interface. This example 200 is depicted using first, second, and third stages 202, 204, 206. At the first stage 202, a single input is received via a user interface that indicates coordinates with respect to a digital image, e.g., through a single click of a cursor control device, tap gesture, and so forth. The single input is used to indicate a location of an input distractor in the user interface.

At the second stage 204, indications are output in the user interface 110 of the input distractor and a plurality of candidate distractors that correspond to the input distractor. The indications are usable to verify that the distractors are to be removed. Responsive to an input received to authorize removal, the distractors are removed (e.g., using object replacement and/or hole filling implemented using a machine-learning module), a result of which is shown at the third stage 206. Examples of implementation of the repeated distractor detection are described in further detail in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Repeated Distractor Detection

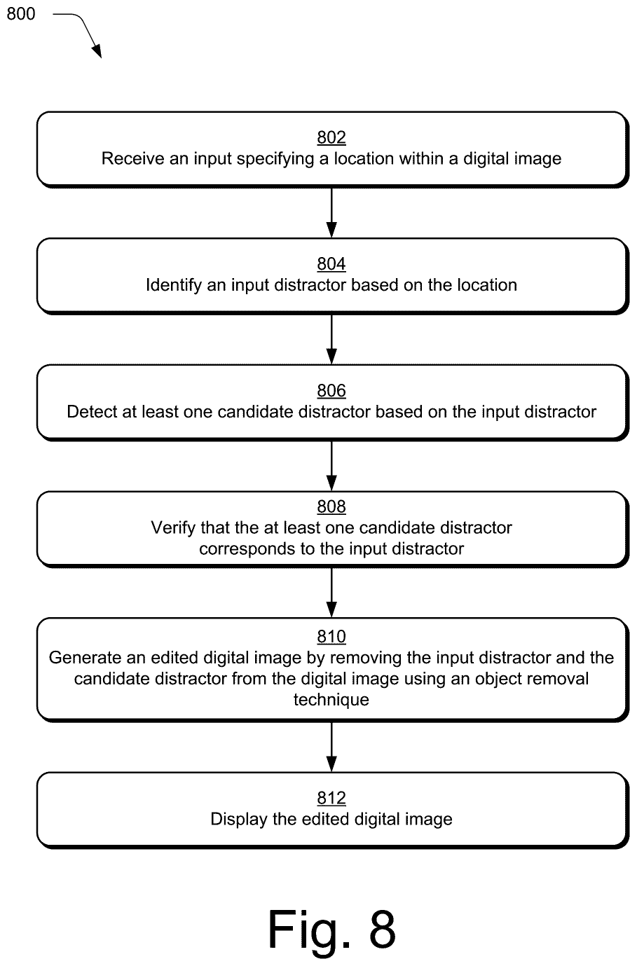

The following discussion describes repeated distractor detection techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform algorithm. In portions of the following discussion, reference will be made to FIGS. 1-7. FIG. 8 is a flow diagram depicting an algorithm as a step-by-step procedure 800 in an example implementation of operations performable for accomplishing a result of automated repeated distractor detection and removal. Discussion of FIG. 8 is made in parallel with a discussion of FIGS. 1-7 in the following description.

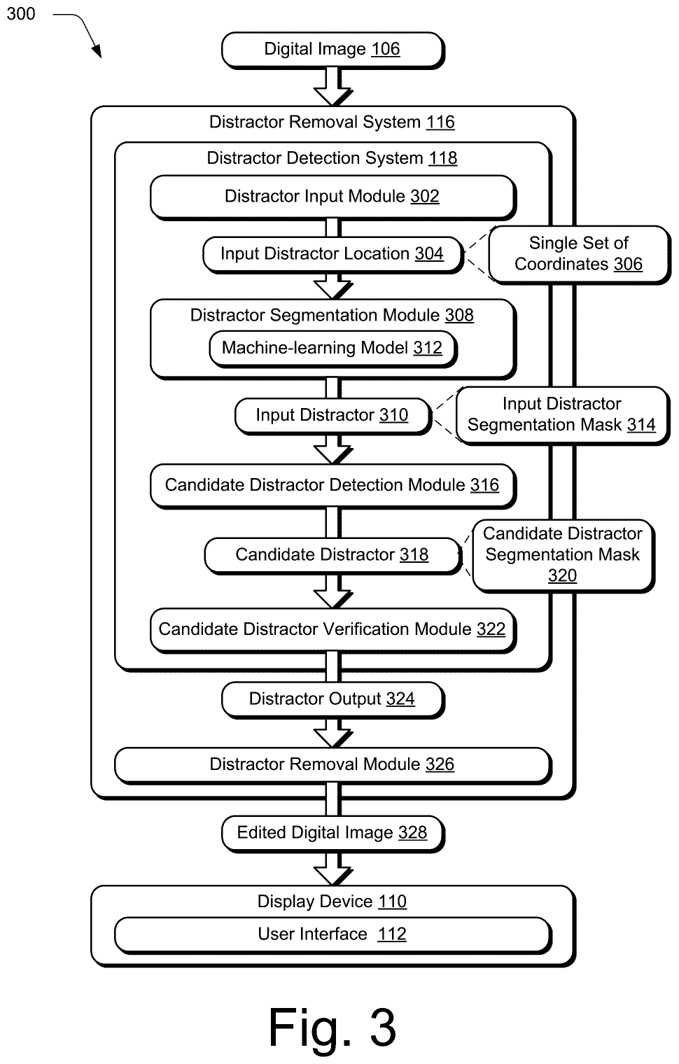

FIG. 3 depicts a system 300 in an example implementation showing operation of the distractor detection system 118 of the distractor removal system 116 of FIG. 1 in greater detail as detecting distractors that are repeated in a digital image responsive to a single user input. To begin in this example, a digital image 106 is received by the distractor removal system 116 and displayed in a user interface 110 by the display device 112 as depicted in FIG. 1.

An input is then received by the distractor detection system 118 of the distractor removal system 116 specifying a location within a digital image 106 (block 802). A distractor input module 302, for instance, generates an input distractor location 304 based on a single input received via an input device, e.g., a “click” by a cursor control device, a display device 112 having touchscreen functionality as a tap gesture, and so forth. The input distractor location 304 is configurable as a single set of coordinates 306 (e.g., X/Y coordinates) defined with respect to the digital image 106 via the user interface. Thus, the single set of coordinates 306 define a location with respect to the digital image 106 that is to be used as a basis to indicate a location of a distractor that is to be removed.

The input distractor location 304 is passed by the distractor input module 302 as an input to a distractor segmentation module 308. The distractor segmentation module 308 is then employed to identify an input distractor 310 based on the input distractor location 304 using a machine-learning model 312 (block 804).

The machine-learning model 312, for instance, is configured to generate an input distractor segmentation mask 314 that indicates a location of the input distractor 310 within the digital image 106. To do so, the machine-learning model 312 is configured to implement an interactive segmentation model that is configured to segment objects having unknown classes. The machine-learning model 312, for instance, is configured to implement a single-click distractor network that given an input digital image, produces a pyramid feature map. Each feature level is paired in this example with a binary click map which indicates a spatial location of a respective “click,” i.e., the input distractor location 304. The embedded feature map is then convolved and concatenated along a feature dimension.

The features maps are processed as inputs received by a detection head and segmentation head of the machine-learning model 312. In an implementation, a bounding box strategy is implemented in which bounding boxes are maintained, solely, that overlap the input distractor location 304 at the respective levels. The machine-learning model 312, as implementing a segmentation model, outputs a plurality of binary segmentation masks corresponding to the input distractor location 304. The machine-learning model 312 is trainable using loss functions that are formed as a combination of detection loss and a Dice loss function that is based on a Dice coefficient, which is a statistical measure of similarity between two digital images. A variety of other examples are also contemplated, e.g., as implementing two-stage segmentation frameworks.

The input distractor 310 (e.g., configured as an input distractor segmentation mask 314) is then passed from the distractor segmentation module 308 to a candidate distractor detection module 316. The candidate distractor detection module 316 is configured to detect at least one candidate distractor 318 based on the input distractor 310 (block 806). The candidate distractor 318 in the illustrated example is also identified using a segmentation mask, which is represented as a candidate distractor segmentation mask 320 in the illustrated example.

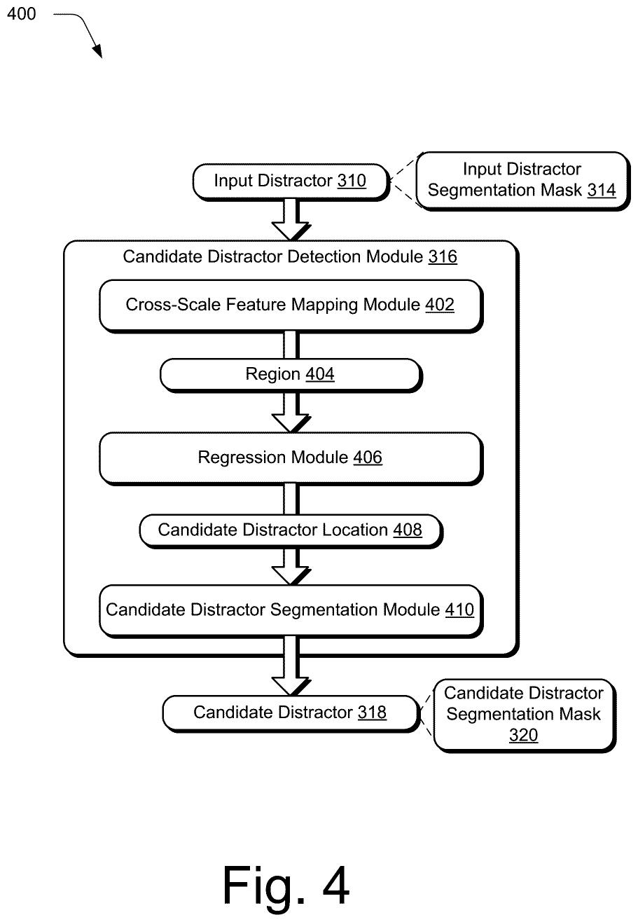

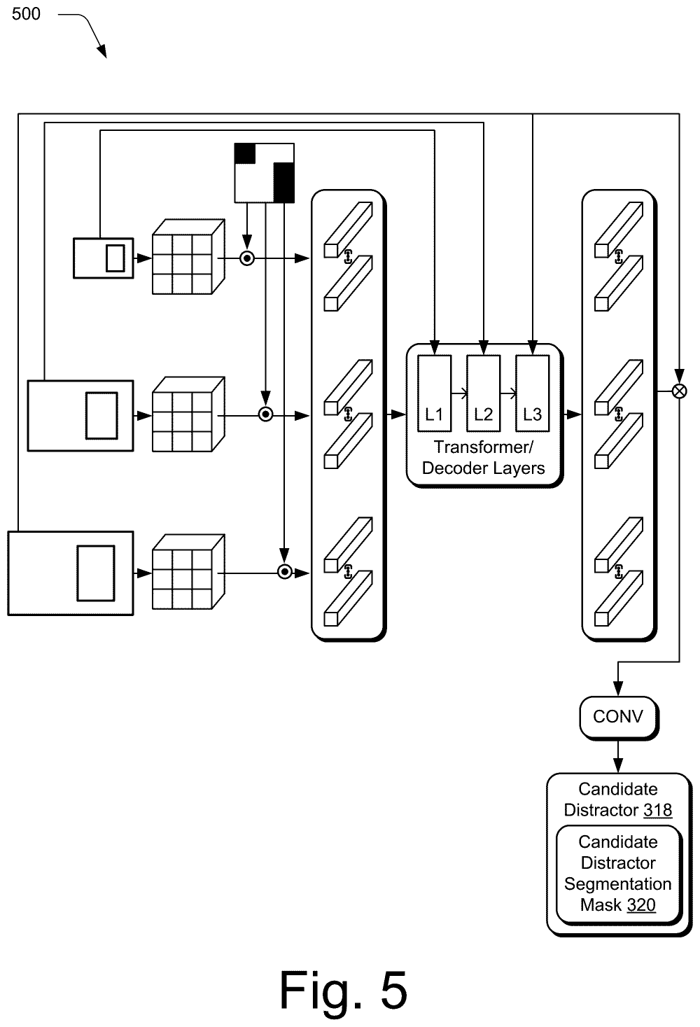

FIG. 4 depict a system 400 in an example implementation showing operation of the candidate distractor detection module 316 of FIG. 3 in greater detail as generating at least one candidate distractor 318 based on an input distractor 310. FIG. 5 depicts an example 500 of an architecture of one or more machine-learning models configurable to implement the candidate distractor detection module 316 of FIG. 4.

As shown in the system 400 of FIG. 4, for instance, the input distractor 310 is received, e.g., configured as an input distractor segmentation mask 314. A cross-scale feature mapping module 402 is configured to identify a region 404 within the digital image 106 that corresponds to the input distractor 310. The region 404 is identified using feature mapping based on features extracted from the input distractor 310 using the input distractor segmentation mask 314 and regions from the digital image 106, e.g., patches.

A regression module 406 is then employed to identify a candidate distractor location 408 based on the region 404. The regression module 406, for example, employs a regression operation to “shrink” the region 404 to a single set of coordinates (e.g., X/Y coordinates) as a centroid, successive boundary reductions, and so forth.

A candidate distractor segmentation module 410 is then employed to generate the candidate distractor 318, e.g., identified as a candidate distractor segmentation mask 320. The candidate distractor segmentation module 410, for instance, is configured to operate similarly to the machine-learning model 312 of the distractor segmentation module 308 to “grow” the candidate distractor location 408 using segmentation-based techniques.

In the example 500 of FIG. 5, the input to the candidate distractor detection

module 316 is the input distractor segmentation mask 314, which is a single query mask predicted using the machine-learning model 312 of the distractor segmentation module 308 described above as well as the feature pyramid. Three levels of feature maps are employed with corresponding spatial resolutions, e.g., to be one-quarter, one-eighth, and one-sixteenth of a size of the digital image 106. Features are then extracted from the three levels of maps, e.g., using feature extraction as further described by Kaiming HE, Georgia Gkiozari, Piotr Dollar, and Ross Girshick. Mask r-cnn. In Proceedings of the IEEE international conference on computer vision, pages 2961-2969, 2017, the entire disclosure of which is hereby incorporated by reference.

Features are extracted from the three levels of maps and resized to “3×3×d,” where “d” is a dimension of features. The binary query mask is then applied to “zero-out” non-masking feature regions. Features vectors are obtained (e.g., “3×9”) and used as a basis to compare similarity with original feature maps. The query vectors are provided as an input into a cascade of transformer/decoder layers illustrated as “L1,” “L2,” and “L3,” in which each layers processes keys and values from different respective levels of the feature maps. The aggregated feature vector is then used to conduct spatial convolution with a largest of the three feature maps in the illustrated example to generate the at least one candidate distractor 318 as a candidate distractor segmentation mask 320.

During training of the machine-learning model in one or more examples, a ground truth heatmap is generated using Gaussian filtering of the map. The kernel size of the Gaussian filter is set to a minimum value of a height and width of each mask. The model is then trained using a penalty reduced pixel-wise logistic regression with a focal loss. During inference, non-maximum suppression (NMS) is applied to the map to retain values within an “s×s” window, with locations chosen having a confidence over a threshold amount.

Returning again to the system 300 of FIG. 3, the candidate distractor 318 is then passed as an input to a candidate distractor verification module 322. The candidate distractor verification module 322 is configured to verify that the candidate distractor 318 corresponds to the input distractor 310. To do so, the candidate distractor verification module 322 compares candidate distractor image features extracted from the at least one candidate distractor with input distractor image features extracted from the input distractor (block 808).

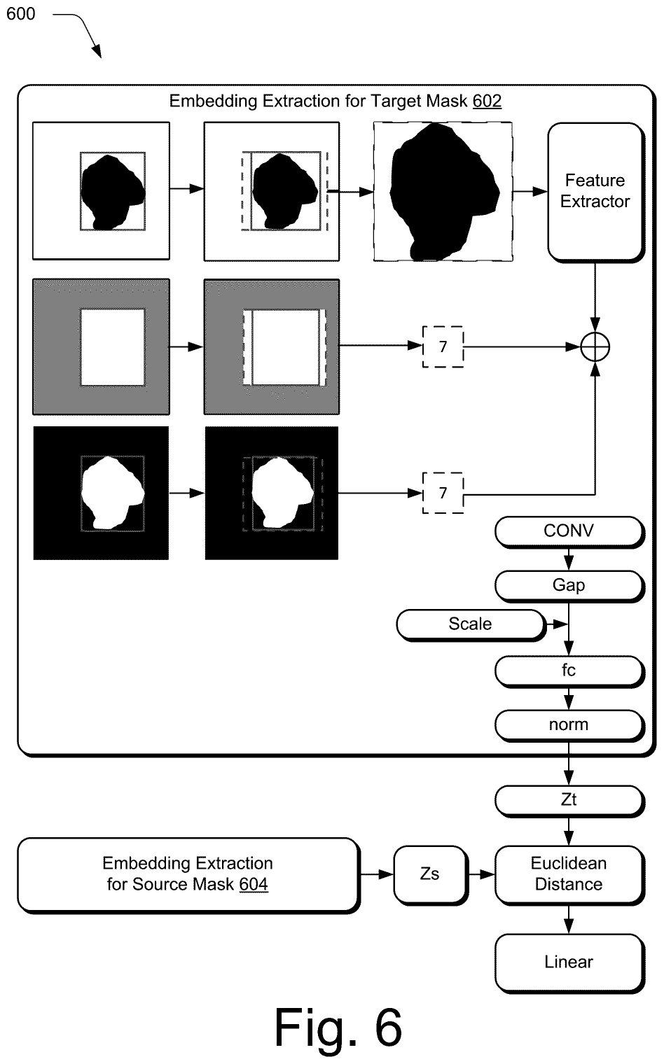

FIG. 6 depicts an example 600 of an architecture of one or more machine-learning models configurable to implement the candidate distractor verification module of FIG. 3. The architecture in this example supports embedding extraction for a target mask 602 (e.g., input distractor segmentation mask 314) and embedding extraction for a source mask 604, e.g., the candidate distractor segmentation mask 320.

The candidate distractor detection module 316 is tasked with comparing features of a 310 with regions taken from the digital image 106 (e.g., patches), which may introduce false positives. To address this technical challenge, the candidate distractor detection module 316 is configured to verify correspondence of the candidate distractor 318 with the input distractor 310. A plurality of candidate distractor segmentation masks 320 generated for corresponding candidate distractors 318, for example, are compared pairwise between each candidate distractor and input distractor. Candidates that cause generation of a mask different that the initial input distractor segmentation mask 314 by more than a threshold are removed.

In the illustrated example 600 of FIG. 6, embedding extraction for the target mask 602 functionality is illustrated as including a first row that corresponds to an image, a second row that depicts extracted features, and a third row that depicts a mapping. Candidate distractor locations 408 of corresponding candidate distractor 318 are processed as inputs by the machine-learning model 312 of the distractor segmentation module 308, which is used to generate segmentation masks as previously described, i.e., the input distractor segmentation mask 314 and the candidate distractor segmentation mask 320. Target masks in FIG. 6 refer to the input distractor segmentation mask 314 and the candidate distractor segmentation mask 320 are referred to a source masks in this part of the discussion.

Given an original digital image 106, extracted features, and segmentation mask, a region of interest is generated. To preserve an aspect-ratio of the object, a bounding box is extended into a square and features are extracted, e.g., using feature extraction as further described by Kaiming HE, Georgia Gkiozari, Piotr Dollar, ad Ross Girshick. Mask r-cnn. In Proceedings of the IEEE international conference on computer vision, pages 2961-2969, 2017. The cropped image patch is resized (e.g., to “224×224”) and processed by a feature extractor, which are then concatenated along with the originally input features and resized mask. A result of which is fed into neural layers to obtain feature embeddings for the target and the source. A scaling factor may be applied to guide learning as part of the embedding. A Euclidean distance between the feature embeddings for the target and source (e.g., for Zt and Zs) is input to a next fully connected layer with a sigmoid activation to output a similarity score, e.g., between “0” and “1.”

In training, sample pairs are randomly sampled from a same digital image. A pair is considered positive if it is drawn from a same category, otherwise the pair is considered negative. A binary cross entropy loss is computed on a last output with the pair labels, and a max-margin contrastive loss is integrated on the feature embedding to increase efficiency in training the model. A final training loss is implemented as a linear combination of these losses.

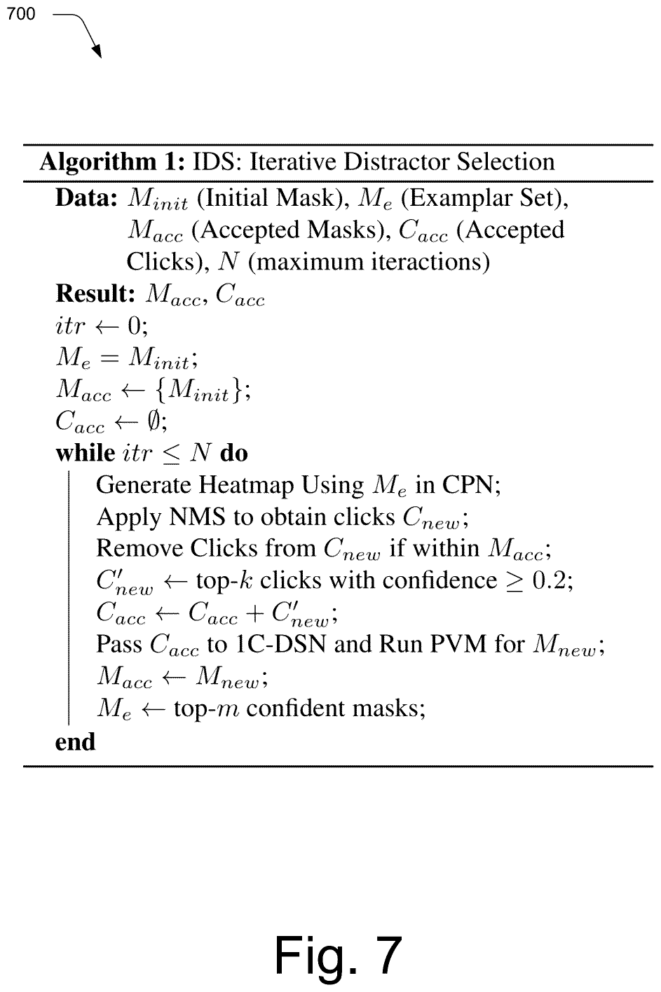

FIG. 7 depicts an example algorithm 700 of iterative distractor selection. In this example, an iterative process is described to increase a number of similar candidate distractors to promote an ability to locate each of the distractors included in the digital image 106 in response to a single input, e.g., a single coordinate.

In the pseudo-code of the example algorithm 700, for each iteration, “Me” is updated with the correct masks and locations (e.g., “clicks”) with increasing amount of confidence are added to the result. Through this updating technique, incorrect similarity findings caused by an incomplete exemplar mask are avoidable. In practice, it has been observed that picking “top-k” clicks (i.e., locations) reduces false positive rates.

Returning again to FIG. 3, a distractor output 324 is generated by the distractor detection system 118, e.g., which identifies the input distractor 310 using the input distractor segmentation mask 314 and the candidate distractor 318 using the candidate distractor segmentation mask 320. A distractor removal module 326 is then employed to generate an edited digital image by removing the input distractor 310 and the candidate distractor 318 from the digital image 106 using an object removal technique (block 810), e.g., a “hole filling” or “inpainting” technique implemented by a machine-learning model. The edited digital image 328 is then displayed as having the input distractor 310 and the at least one candidate distractor 318 removed from the digital image 106 (block 812).

Accordingly, these techniques are configured to address technical challenges in identifying what is considered a distractor in a digital image as well as how to support group selection of distractors, e.g., based on a single input.

### Example System and Device

FIG. 9 illustrates an example system generally at 900 that includes an example computing device 902 that is representative of one or more computing systems and/or devices that implement the various techniques described herein. This is illustrated through inclusion of the distractor removal system 116. The computing device 902 is configurable, for example, as a server of a service provider, a device associated with a client (e.g., a client device), an on-chip system, and/or any other suitable computing device or computing system.

The example computing device 902 as illustrated includes a processing device 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 904 is representative of functionality to perform one or more operations using hardware. Accordingly, the processing device 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912 that stores instructions that are executable to cause the processing device 904 to perform operations. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing device 904. The instructions and/or functions are executable/operable by one or more articles of manufacture (for example, one or more computing devices 902 and/or processing devices 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

In implementations, the platform 916 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, an input specifying a location within a digital image;
identifying, by the processing device, an input distractor based on the location, the identifying performed using a machine-learning model;
detecting, by the processing device, at least one candidate distractor based on the input distractor;
verifying, by the processing device, that the at least one candidate distractor corresponds to the input distractor by comparing candidate distractor image features extracted from the at least one candidate distractor with input distractor image features extracted from the input distractor; and
displaying, by the processing device, an edited digital image having the input distractor and the at least one candidate distractor removed from the digital image.

2. The method as described in claim 1, wherein the identifying the input distractor includes generating an input distractor segmentation mask based on the input distractor location using the machine-learning model.

3. The method as described in claim 1, wherein the detecting the at least one candidate distractor includes identifying a region within the digital image that corresponds to the input distractor using feature matching based on the input distractor and the region.

4. The method as described in claim 3, wherein the feature matching includes cross-scale feature matching.

5. The method as described in claim 3, further comprising identifying a candidate distractor location within the digital image by a regression operation as applied to the region.

6. The method as described in claim 5, wherein detecting the at least one candidate distractor includes generating a candidate distractor segmentation mask as identifying the at least one candidate distractor based on the candidate distractor location.

7. The method as described in claim 1, further comprising generating the edited digital image by removing the input distractor and the candidate distractor from the digital image using an object removal technique implemented using machine learning.

8. The method as described in claim 1, wherein the candidate distractor image features and the input distractor image features are extracted using a machine-learning model.

9. The method as described in claim 1, wherein the input is a single input specified using a single set of coordinates.

10. The method as described in claim 9, wherein the input is a single click input using a cursor control or single tap as a gesture received via a user interface.

11. A computing device comprising:
a processing device; and
a computer-readable storage medium storing instructions that, responsive to execution by the processing device, causes the processing device to perform operations including:
generating an input distractor segmentation mask based on a single coordinate position with respect to a digital image, the input distractor segmentation mask identifying an input distractor in the digital image;
generating a candidate distractor segmentation mask based on the input distractor segmentation mask, the candidate distractor segmentation mask identifying a candidate distractor in the digital image;
verifying that image features extracted from the digital image using the input distractor segmentation mask correspond to image features extracted from the digital image using the candidate distractor segmentation mask; and
outputting the input distractor segmentation mask and the candidate distractor segmentation mask.

12. The computing device as described in claim 11, wherein the candidate distractor image features and the input distractor image features are extracted using a machine-learning model.

13. The computing device as described in claim 11, wherein the generating the candidate distractor segmentation mask includes identifying a region within the digital image that corresponds to the input distractor using feature matching based on the input distractor and the region.

14. The computing device as described in claim 13, wherein the feature matching includes cross-scale feature matching.

15. The computing device as described in claim 13, further comprising identifying a candidate distractor location within the digital image by a regression operation as applied to the region and the generating of the candidate distractor segmentation mask is based on the candidate distractor location.

16. The computing device as described in claim 11, wherein the operations further comprise generating an edited digital image by removing the input distractor and the candidate distractor from the digital image using an object removal technique implemented using machine learning.

17. One or more computer-readable storage media storing instructions that, responsive to execution by a processing device, causes the processing device to perform operations including:
generating an input distractor segmentation mask identifying an input distractor based on a location specified with respect to a digital image;
identifying a region within the digital image that corresponds to the input distractor using feature matching;
identifying a candidate distractor location within the digital image by a regression operation as applied to the region;
generating a candidate distractor segmentation mask as identifying at least one candidate distractor based on the candidate distractor location; and
generating an edited digital image using an object removal technique based on the digital image, the input distractor segmentation mask, and the candidate distractor segmentation mask.

18. One or more computer-readable storage media as described in claim 17, wherein the operations further comprise verifying that the candidate distractor corresponds to the input distractor by comparing candidate distractor image features extracted based on the candidate distractor segmentation mask with input distractor image features extracted based on the input distractor segmentation mask.

19. One or more computer-readable storage media as described in claim 17, wherein the candidate distractor location is indicated using a single set of coordinates with respect to the digital image.

20. One or more computer-readable storage media as described in claim 17, wherein the location of the input distractor is specified responsive to a user input received via a user interface specifying a single set of coordinates with respect to the digital image.
